(19) United States
(12) Patent Application Publication
(10) Pub. No.: US 2013/0311279 A1
(43) Pub. Date: Nov. 21, 2013

(54) Methods and Systems for Advertising and Facilitating Consumer-Related Activities Including Pay-Per-Redemption Methods and Electronic Voucher Use, Storage, and Management

(71) Applicant: Hai M. Bui, Santa Clara, CA (US)

(72) Inventor: Hai M. Bui, Santa Clara, CA (US)

(73) Assignee: Adobe Systems Incorporated, San Jose, CA (US)

(21) Appl. No.: 11/782,934

(22) Filed: Jul. 25, 2007

(51) Int. Cl. G06Q 30/00

(52) U.S. Cl. 705/14.51

(57) ABSTRACT

Methods and systems for associating advertising, promotions, redeemable rewards, payments and/or transactions to implement pay-per-redemption and similar advertising methods and for using, storing, and managing electronic vouchers. One embodiment provides a method of associating advertising with a transaction. The method may comprise determining a fee arrangement between a first entity and a second entity based on completion of transactions associated with electronic advertisements. The method may comprise providing to a recipient an electronic advertisement associated with an electronic voucher offering redemption of a benefit in return for completion of a transaction using the electronic voucher. And, the method may comprise receiving an advertising fee from the second entity according to the fee arrangement as a result of completion of a transaction using the electronic voucher. Another method comprises providing an electronic voucher from a voucher-source to a voucher-recipient, receiving an instruction to use die electronic voucher with a transaction between the voucher-recipient and a transaction-entity, completing the transaction using the electronic voucher, providing the benefit of the electronic voucher to the voucher-recipient, and associating the transaction with the voucher-source.

### FIELD OF THE INVENTION

The present invention relates generally to electronic advertising and related consumer activities, including methods and systems that provide advertisements through or with electronic vouchers and associate fees based on transactions resulting from the advertisements.

### BACKGROUND

A pay-per-click advertising model is commonly used for advertisements on the Web, Internet, e-mail, and in other electronic formats. The model typically involves advertising a product or service in an electronic format and recognizing when a user selects an advertisement. The selection of an advertisement is typically referred to as clicking on advertisement. For example, a user may select an advertisement by clicking on an image on a Web page with an input device, such as a mouse, to learn more about a product advertised by the image. Typically the click links the user to another Web page about the product. The number of selections or clicks that a given advertisement receives is recorded and used to determine the amount a merchant pays for the advertisement. Generally, the merchant pays the third-party advertiser who has provided the advertisement to the user.

In such pay-per-click models, the number of clicks is used as a measure of the effectiveness of the advertisement, based on the belief that, merchants are willing to pay more for more effective advertising. However, a significant limitation of the pay-per-click advertising model is its susceptibility to fraud, for example, through the use of scripts that simulate clicks to falsely increase advertising costs. Attempts to filter illegitimate clicks have had limited and generally unproven success.

Pay-per-click advertising models involve Web advertisements in a variety of forms, including banner advertisements, context sensitive advertisements, and coupons. For example, a Web page may provide a coupon code and a link to the merchant's Web site, may generate revenue when a user clicks on the link, and may require the user to enter the code on the merchant's Web site. Such code-based coupons offer various advantages but, as presently used, have limited usefulness because they suffer from the limitations of the of pay-per-click model, including the susceptibility to fraud described above and the inconvenience frequently imposed on the recipients, for example, having to record and enter codes, etc. Present electronic advertising models, in general, are limited in features and flexibility, susceptible to fraud, and are generally inadequate in associating an advertisement's effectiveness with its cost.

### SUMMARY

Embodiments of the present invention provide methods and systems for associating advertising with a transaction. Certain embodiments relate to the use of files and other electronically-transmitted items that identify an entity, product, service, transaction, and/or reward, such transmittable items referred to herein as electronic vouchers (E-Vouchers). Other embodiments relate to the use of an E-Voucher depository, and pay-per-redemption advertising models. Generally, embodiments of the present invention allow merchants and other transaction entities to offer discounts or other transaction-enticing benefits through E-Vouchers and pay advertising fees to deserving parties only if a transaction is completed. An E-Voucher depository may be used to facilitate storage and use of these E-Vouchers, among other things.

One embodiment of the present invention is a method comprising providing an E-Voucher from a voucher-source (any entity or machine that provides a voucher) to a voucher-recipient (any entity or machine that receives a voucher). The E-Voucher may offer a benefit to the voucher-recipient in return for completion of a transaction with a transaction-entity (any entity or machine that performs or facilitates the transaction). The method may further comprise receiving an instruction (typically from the voucher-recipient) to use the E-Voucher and completing the transaction between the voucher-recipient and the transaction-entity using the E-Voucher. If completed, the promised benefit of the E-Voucher is provided to the voucher-recipient and the transaction is associated with the voucher-source, so that an appropriate party can be compensated for the successful advertisement,

An E-Voucher may be provided through an electronic advertisement and/or may be stored in an E-Voucher depository. For example, an advertisement recipient may download and/or store the E-Voucher in a depository. The recipient may then use the stored E-Voucher in completing the transaction with the transaction-entity. After or during completion of the transaction, a benefit of the E-Voucher may be provided to the recipient and the transaction may be associated with the voucher-source, so that the voucher-source can be compensated for the successful advertisement.

One embodiment of the invention provides a method of associating advertising with a transaction. The method may comprise determining a fee arrangement between a first entity and a second entity based on completion of transactions associated with electronic advertisements. The method may comprise providing to a recipient an electronic advertisement associated with an E-Voucher offering redemption of a benefit in return for completion of a transaction using the E-Voucher. The E-Voucher may be associated with and downloadable from the electronic advertisement, for example, upon or otherwise in response to selection of a button or a link on the advertisement. And, the method may comprise receiving an advertising fee from the second entity according to the fee arrangement as a result of completion of a transaction using the E-Voucher. Delivery of an E-Vouchers is not limited to delivery through the use of Web advertisements. For example, a Web site simply listing merchandise could let users download an E-Voucher by clicking on a button or link associated with a given item.

A pay-per-redemption Web-based advertisement model is a beneficial alternative to the existing pay-per-click models. In one such a pay-per-redemption model, online merchants sponsor Web advertisements that distribute E-Vouchers to Internet users, and only pay the advertisement agency once the E-Vouchers are redeemed, for example, after a purchase has been made or a credit card application has been completed. One advantage is that online merchants only have to pay for an advertisement if the advertisement has been successful in resulting in a transaction. For example, when an Internet user redeems an E-Voucher, a Web advertisement company may be paid by the merchant for having provided the advertisement. For example, the merchant may have agreed to pay the distributor $1 per redemption and may do so upon each redemption.

In other embodiments, a computer-readable medium (such as, for example, random access memory or a computer disk) comprises code for carrying out the methods.

“Transaction” is used to refer to all types of transactions and is not limited to purchase-type transactions, for example, filling out a survey for a benefit is a transaction in the present context. Note further that “benefit” is similarly not limited to any specific type of reward. A transaction entity may be an entity that makes or does not make goods, an entity that does of does not sells services, an online merchant entity that offers its own and/or another's goods, an online entity that offers its own and/or another's services, or any entity with whom a user can conduct an online transaction. Finally, note that the E-Voucher may itself be an advertisement or may be provided as part of an advertisement or provided with an advertisement or as downloadable content delivered.

These embodiments are mentioned not to limit or define the invention, but to provide examples of embodiments of the invention to aid understanding thereof. Embodiments are discussed in the Detailed Description, and further description of the invention is provided there. Advantages offered by the various embodiments of the present invention may be further understood by examining this specification.

### BRIEF DESCRIPTION OF THE FIGURES

These and other features, aspects, and advantages of the present invention are better understood when the following Detailed Description is read with reference to the accompanying drawings, wherein:

FIGS. 1a-c are system diagrams illustrating illustrative network environments according to certain embodiments of the present invention;

FIGS. 2a-c are system flow diagrams illustrating exemplary flows of information according to certain embodiments of the present invention;

FIG. 3 is a flow chart illustrating one method of associating advertising with a transaction according to one embodiment of the present invention; and

FIG. 4 is a flow chart illustrating one method of advertising according to one embodiment of the present invention.

### DETAILED DESCRIPTION

Embodiments of the present invention provide methods and systems for electronic advertising, including methods and systems that provide advertisements and associate fees based on completion of transaction events resulting from the advertisements.

### Illustrative Application of Pay-Per-Redemption Advertising Model

The following specific illustrative embodiment is provided to illustrate some of the applications, uses, and benefits of providing a pay-per-redemption advertising model according to an embodiment of the present invention.

According to an embodiment, a Web page provider provides a Web page displaying a video rental membership advertisement and containing a link or button that, upon user selection, provides an E-Voucher to a user recipient. The E-Voucher specifies a potential benefit that the voucher-recipient can redeem if a specified transaction is completed. Specifically, it specifies that if the recipient applies for a video rental membership with a video rental transaction-entity using the E-Voucher, then the voucher-recipient will get one month of unlimited video rentals for free. The user can click on the link or button to be provided with the E-Voucher.

The voucher itself is an electronic file, such as an XML formatted file, that identifies where or how the voucher may be redeemed. The voucher is downloaded, redeemed, and/or stored in a depository for potential future redemption. The E-Voucher may be immediately redeemed with the video rental membership provider, referred to here as the transaction-entity. Alternatively, the E-Voucher may be stored in a depository for later use. The depository in this example is located and managed on the voucher-recipient's computer, but could be located and/or managed remotely.

The voucher-recipient goes to a membership-signup Web page provided by the video rental membership provider and presents the E-Voucher. If the voucher-recipient then signs up for the video rental membership, the video rental membership provider provides the promised benefit to the voucher-recipient—the one month of unlimited video rentals for free. The content of the B-Voucher also allows identification of the Web advertisement provider that delivered the E-Voucher. Consequently, upon the new membership sign-up, the video rental membership provider knows which Web advertisement provider is to be paid with an appropriate advertising fee for the successful advertisement, proven by the voucher-recipient's completed transaction

The advertising fees paid to the Web page provider for advertisements may thus be based on successful transactions. This type of pay-per-redemption advertising model offers many other advantages, including advantages over the presently used pay-per-click advertising models. For example, the pay-per-redemption model is less susceptible to click fraud since the advertising fee may be tied to actual redemption rather than anonymous clicks.

Instead of redeeming the E-Voucher immediately, the user may have selected to store the voucher in a depository for potential redemption at a later time. One or more E-Vouchers may be stored in a local depository on the voucher-recipient's computer or at a remote depository, remote from the voucher-recipient's computer. If the voucher-recipient does not redeem the voucher, reminders may be provided to the recipient. Such reminders may be periodic, based on voucher expiration (for example, if a benefit is only redeemable for a limited time), or based on any other suitable triggering event including the voucher-recipients' visiting a Web page related to the video rental membership provider or to the general subject matter of video renting that is likely of continuing interest to the user. If the user decides to actively search for an E-Voucher, recommendations for E-Vouchers can be provided based on a variety of factors, including the user search criteria and other factors, such as the data that is available to the system, the degree or type of discount searched for, etc., and/or by the use of software algorithms or software applications.

When the voucher-recipient collects one or more E-Vouchers without redeeming them, the E-Vouchers can be stored and managed on an account at an Internet voucher depository service. The voucher-recipient can control access to the account to allow or not allow others to have access to the account. If access is allowed, then the video rental membership provider might recognize that the E-Voucher has been stored and send the voucher-recipient a targeted advertisement or other offers. Likewise, a competitor video rental membership provider might recognize that the E-Voucher has been stored and send the voucher-recipient its own targeted advertisement or other offer, if the depository is stored on a user's local machine, the user can specify whether to grant access and to whom.

When the voucher-recipient visits a Web site, the visited Web site might check the voucher-recipient's account for relevant vouchers. So if the user goes to the video rental membership's Web site, the Web site recognizes the user and that the user has an account with an unexpired voucher in it related to the video rental membership signup offer. The Web site may then automatically ask the user if the user desires to redeem the E-Voucher and otherwise facilitate completion of the signup by retrieving and using the E-Voucher.

These illustrative examples ate given to introduce the reader to the general subject matter discussed herein. The invention is not limited to these examples nor any aspect of them. The following sections describe various additional embodiments and examples of methods and systems for advertising.

### Illustrative Network Configurations far Advertising

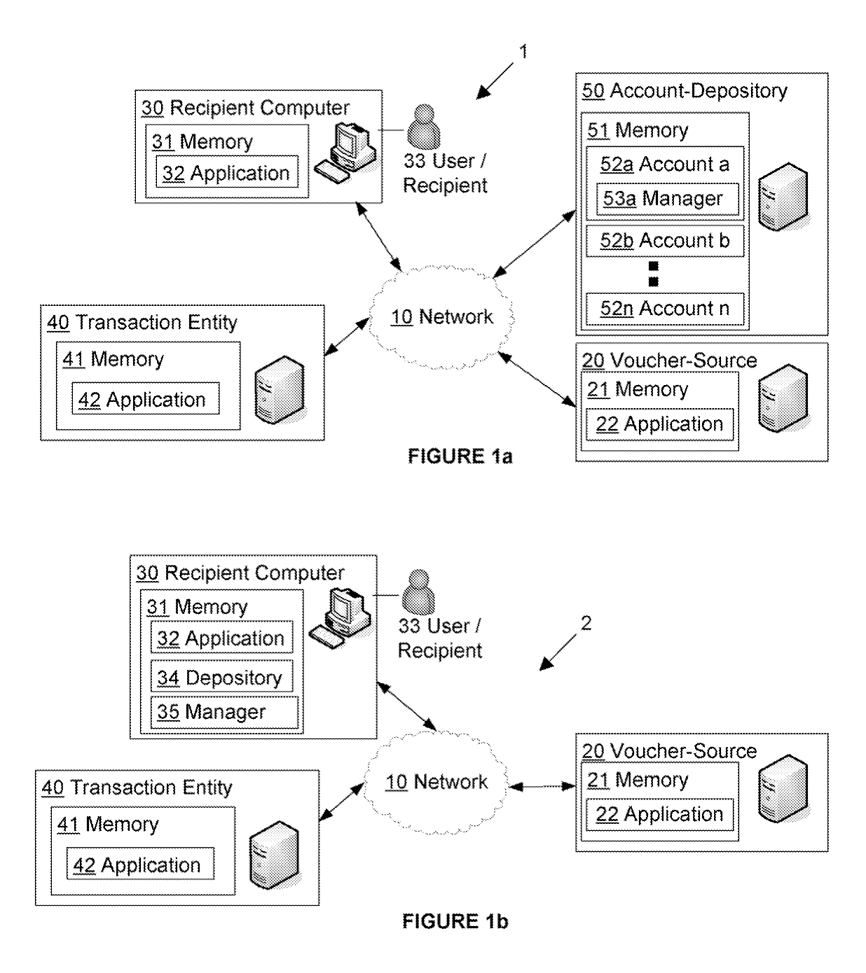

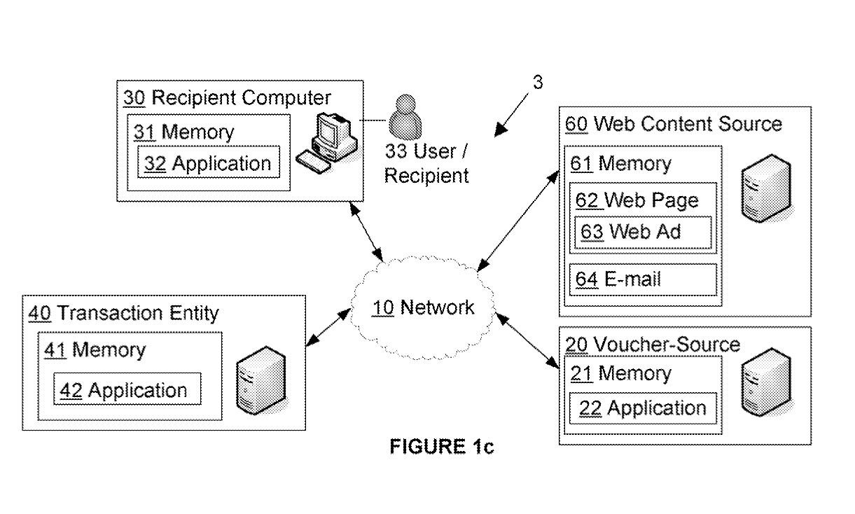

Referring now to the drawings in which like numerals indicate like elements throughout the several figures, FIGS. 1a-c are system diagrams showing illustrative network environments according to certain embodiments of the present invention Other embodiments may be utilized.

The systems 1, 2, 3 shown in FIGS. 1a-e comprise a wired or wireless network 10 connecting various combinations of server devices 20, 40, 50, 60 and a client computer, referred to here as a voucher-recipient computer 30 executing an Internet application 32. Applications that execute on each of the devices 20, 30, 40, 50, 60 are shown as functional components residing in memory 21, 31, 41, 51, 61 on the respective devices. As is known to one of skill in the art, such applications may be resident in any suitable computer-readable medium and execute on any suitable processor. For example, the network devices 20, 30, 40, 50, 60 shown each may comprise a computer-readable medium such as a random access memory (RAM) 21, 31, 41, 51, coupled to a processor that executes computer-executable program instructions stored in memory 21, 31, 41, 51, 61. Such processors may comprise a microprocessor, an ASIC, a state machine, or other processor, and can be any of a number of computer processors, such as processors from Intel Corporation of Santa Clara, Calif. and Motorola Corporation of Schaumburg, Ill. Such processors comprise, or may be in communication with, media, for example, computer-readable media, which stores instructions that, when executed by the processor, cause the processor to perform the steps described herein.

Embodiments of computer-readable media comprise, but are not limited to, an electronic, optical magnetic, or other storage or transmission device capable of providing a processor with computer-readable instructions. Other examples of suitable media comprise, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

The network 10 shown comprises the Internet. In other embodiments, other networks, such as an intranet, or no network may be used. Moreover, methods according to the present invention may operate within a single device. The devices 20, 30, 40, 50, 60 can be connected to a network 10 as shown. Alternative configurations are of course possible. The devices 20, 30, 40, 50 may also comprise a number of external or internal devices such as a mouse, a CD-ROM, DVD, a keyboard, a display, or other input or output devices. Examples of devices that could execute an Internet application 32 are personal computers, digital assistants, personal digital assistants, cellular phones, mobile phones, smart phones, pagers, digital tablets, laptop computers, Internet appliances, and other processor-based devices. In general, a computer device executing the Internet application 32 may be any type of processor-based platform that operates on any operating system, such as Microsoft® Windows® or Linux, capable of supporting one or more client-application programs. Other client applications can be contained in memory and can comprise, for example, a word processing application, a spreadsheet application, an e-mail application, a media player application, an instant messenger application, a presentation application, an Internet browser application, a rich Internet application player 32, a calendar/organizer application, and any other application or computer program capable of being executed by a client device. Any one or more of these applications may be used to receive, request, or provide an advertisement or E-Voucher or may otherwise be used in the voucher provision, voucher redemption, and other advertising features forming part of the present invention.

The server devices 20, 40, 50 depicted as single computer systems, may be implemented as a network of computers or processors. Examples of a server device are servers, mainframe computers, networked computers, a processor-based device, and similar types of systems and devices.

For FIG. 1a, a user 33, using the voucher-recipient computer 30, may provide an instruction to receive an E-Voucher. In response to the instruction, the application 32 sends a request to voucher-source 20, and voucher-source 20, through a voucher providing application 22, sends an E-Voucher to the account depository 50 for storage in an account 52a associated with the user. The E-Voucher account depository may have multiple accounts 52a-n for multiple users. Each account is a separate E-Voucher depository and each has an associated E-Voucher management tool, for example the first account 52a may act as a depository for E-Vouchers collected by a single user and utilize a manager 53a. The user 33, also referred to as the voucher-recipient may initiate redemption of the E-Voucher, for example, by sending a redemption request rising the Internet application 32 to the E-Voucher account depository 50 and/or the transaction-entity 40. For example, the transaction-entity may be an online merchant and the transaction may be an online purchase made with the vendor recipient accessing the merchant's Web site. The voucher-depository 50 sends the E-Voucher to the transaction-entity and the user 33 completes a transaction with the transaction-entity 40 to redeem a benefit associated with the E-Voucher.

For FIG. 1b, a voucher-source 20 through a voucher providing application 22 sends an E-Voucher to the local voucher depository 34 at the recipient computer 30. The voucher-recipient 33 may initiate redemption of the E-Voucher, for example, by instructing the local voucher depository 34 to send the E-Voucher to the transaction-entity. Again, the user 33 may complete the transaction with the transaction-entity 40 to redeem a benefit associated with the E-Voucher.

For FIG. 1c, an illustrative Web content source 60 may provide an advertisement to the voucher-recipient computer 30 through network 10. For example, the web content source may provide a Web page 62 or an e-mail 64 that advertises a product or service associated with the transaction-entity as part of an advertising arrangement between the Web content source 60 and the transaction-entity 40. The advertisement within the provided content 62, 64 may offer an E-Voucher, for example, by offering a link to download an electronic voucher. The user 33 may elect to receive or use the E-Voucher. In some cases, the user 33 will store the E-Voucher (for example, in a depository) and in other cases the user 33 will elect to immediately redeem the E-Voucher.

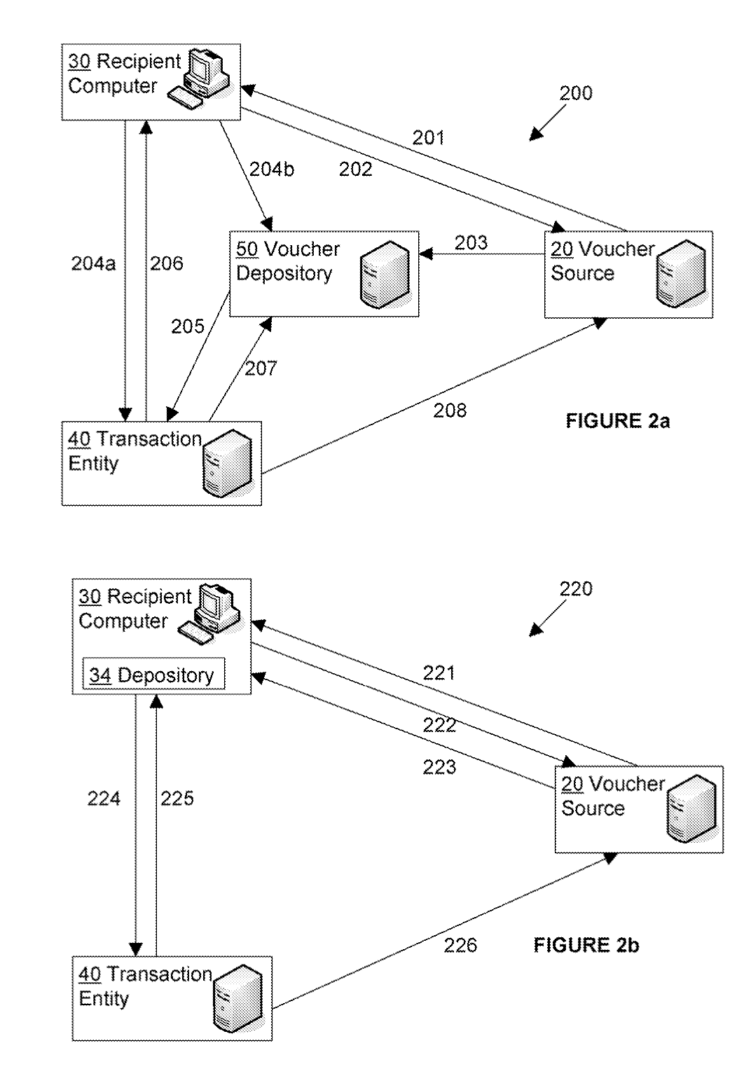

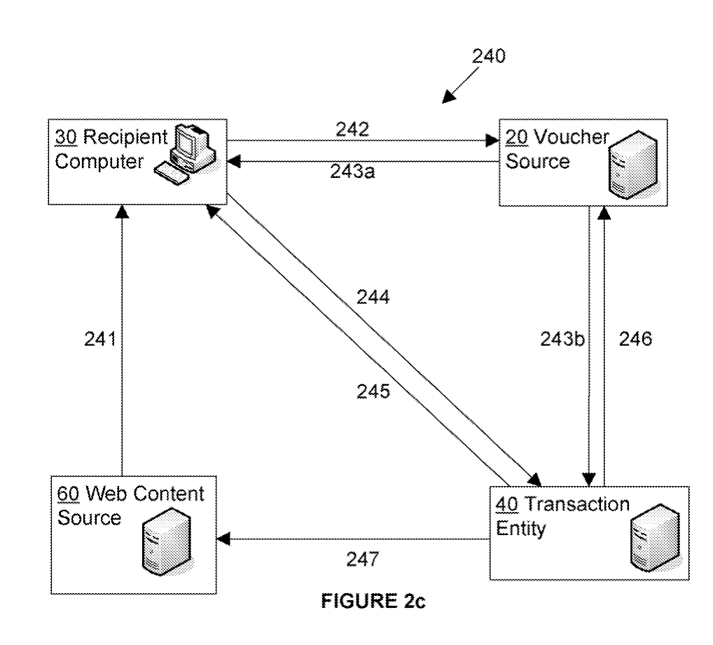

FIGS. 2a-c are system flow diagrams illustrating exemplary flows of information according to certain embodiments of the present invention. For FIG. 2a, voucher-source 20 provides or identifies an E-Voucher in a message 201 to a voucher-recipient who elects to receive or use the E-Voucher by providing an instruction 202, for example, to request download of the E-Voucher. Following this instruction, the E-Voucher 203 is provided to the account depository 50. The E-Voucher is redeemed when the user completes a transaction with the transaction-entity 40. Such a transaction may involve the voucher-recipient sending an initiating message 204b to the transaction-entity 204a or an initiating message to the account depository 50, which then facilitates the transaction 205 by, for example, connecting the voucher recipient 30 to the transaction-entity 40 and/or by providing the E-Voucher to the transaction-entity. Initiating the transaction 204a, 204b may involve the voucher recipient taking an action specified by the E-Voucher and receiving in return a benefit 206 promised by the terms of the E-Voucher. After the transaction is completed, the transaction-entity 40 sends a message 207 to the account depository 50 confirming that the E-Voucher has been redeemed. The transaction-entity 40 further sends a message and/or fee 208 to the voucher-source 20 confirming that the E-Voucher has been redeemed and/or that a fee has been credited to the voucher-source 20 for the success.

Note that a payment to a voucher source can be carried out and otherwise facilitated by a variety of suitable techniques. For example, a transaction entity may simply credit a voucher source after completion of a transaction. Alternatively, a transaction entity may send a message back to the voucher source so that voucher source may calculate a fee to bill the transaction entity, perhaps at a later time. As another alternative, the E-Voucher itself may comprise code that is used to calculate a fee or otherwise initiate or facilitate messages that facilitate payment.

For FIG. 2b, a voucher depository 34 is located at the recipient computer 30. The voucher-source 20 makes-an E-Voucher 221 available to a voucher-recipient or otherwise provides a message, Web page, e-mail or other content 221 informing the user that an E-Voucher is available. The user provides an instruction 222 to receive the E-Voucher. The E-Voucher 223 may then be sent and stored in the depository 34. To redeem the E-Voucher, the voucher-recipient may send a message and/or the E-Voucher itself 224 to the transaction-entity, take the E-Voucher required action, and receive the promised benefit 225. The transaction-entity 40 may send a message and/or fee 226 to the voucher-source 50. A message 226, for example, may convey that the E-Voucher has been redeemed and/or that a fee has been credited to the voucher-source 20. If necessary, the voucher source 20 may determine an appropriate fee based on the message 226 from the transaction entity identifying the completion of a transaction/redemption of an E-Voucher.

For FIG. 2c, a web content source 60 makes an E-Voucher available to a voucher-recipient in content 241. The user provides an instruction 242 to receive the E-Voucher, which may be provided in transaction 243a to the recipient computer and/or in transaction 243b to the transaction entity. In one embodiments, the voucher source 20 provides the E-Voucher, while in another embodiment the web content source 60 acts also as the voucher source 20 or otherwise provides the E-Voucher. Upon redemption 244, the transaction-entity 40 may deliver a confirmation message 245 of the E-Voucher redemption and/or the recipient's benefit of the E-Voucher redemption to the recipient 30. To credit/pay the voucher source for the redemption, a message will generally be sent from the transaction-entity 40. The transaction-entity 40 may send a confirmation message or fee 246 to the voucher-source 20 or web content source 60 and/or a confirming message 247 and/or fee to the Web content source 60. In one embodiment, the E-Voucher sends the confirmation message without control or even awareness by the transaction-entity. For example, the E-Voucher could be a script-based or binary file, executable by or at the transaction entity. When a customer redeems an. E-Voucher, the E-Voucher authenticates itself with the transaction-entity 40, and, sends a message to its E-Voucher source 20 to signify that a redemption is in progress, has completed, or at any stage of a redemption process.

Certain embodiments of the present invention relate to pay-per-redemption advertising models, the use of E-Vouchers, and the use of an E-Voucher depository. It will be recognized that these are merely illustrative of the context for the methods of advertising and other features of the invention described herein. For example, certain embodiments will not involve an E-Voucher depository, certain embodiments will not involve the use of a pay-per-redemption advertising model, and certain embodiments will not involve an E-Voucher. In short the techniques for advertising and the other features described herein have uses in a variety of contexts, not to be limited by the specific illustrations provided herein.

It should also be noted that embodiments of the present invention may comprise systems having different architecture and information flows than those shown in FIGS. 1a-c and 2a-c. For example, in some systems according to the present invention, a server device may comprise a single, physical or logical server. In some systems, a voucher-source and Web content source will be combined or associated with a same advertisement providing entity. In some systems, an E-Voucher will be sent to both a recipient computer 30 and a transaction-entity 40, while in other embodiments it will be sent to only one or to neither. The systems shown are merely illustrative and are not intended to indicate that any system component, feature, or information flow is essential or necessary to any embodiment of the invention.

### Illustrative Embodiment of an E-Voucher

Generally, an E-Voucher may be anything that is capable of being transmitted electronically and that identifies either a transaction-entity or a product, service, or transaction. An E-Voucher may be a record of information, and can be a computer file, such as an XML file, or could be binary or script-based. Such a file may contain information about a benefit such as a discount offered to a potential customer or other recipient of the E-Voucher. Such a file may contain a transaction-entity identity such as a name, Web address, entity number, or other identifying information. The file may contain information about any applicable offer restrictions. In one embodiment, an E-Voucher takes the form of an E-Coupon that specifies a purchase price discount on the purchase of a product or service from a particular merchant. In another embodiment, the E-Voucher includes the terms of an offer for a non-purchase transaction, such as, for example, offering to reward a user for filling out a survey with a check for $50 to the user. In another embodiment, an electronic voucher file contains discount information, a merchant name, an expiration date, and offer restrictions.

The electronic form or format of an E-Voucher may facilitate use of the voucher. The electronic format of an E-Voucher may also allow it to be organized, sorted, searched, filtered, recommended, and associated with reminders, among other things. While an E-Voucher is preferably a file, it may be as simple as an Internet cookie or a simple text string. An E-Voucher may be an applet that uses a subset of the Adobe®Flash® standard that can be accessed, for example, by a client application that uses the Adobe®Flash® technology, such as an Adobe® AIR™ application.

An E-Voucher may include a description of an offer, information about the offered benefit, a merchant identification number or sequence, a distributor or referral identification number or sequence, a date from which the offer is valid, an expiration date for the offer, information about a restriction placed on the E-Voucher (for example, a limit on the number of items to which the promised discount may be applied), a link to the merchant's Web site, a transaction Web site, or other information that facilitates a user initiating redemption of the E-Voucher, information about the date on which the voucher was provided or accessed, and information on the time of day that the voucher was provided or accessed. The following is an example of the content, and content format in XML of an exemplary E-Voucher:

<?xml version=“1.0” encoding=“UTF-8”?>
<!-- E-Voucher promotion data -->
<description>...</description> <!-- For example, “Buy one, get one free” -->
<valid_from>...</valid_from> <!-- The date when the E-Voucher becomes effective -->
<valid_through>...</valid_through> <!-- The last effective date of the E-Voucher -->
<restrictions>...</restrictions> <!-- Restrictions of the offer, such as 1 per person, etc. -->
<notes>...</notes> <!-- Other notes, such as redemption instructions or fine prints -->
<!-- E-Voucher origination data -->
<merchant>...</merchant> <!-- The originator of the E-Voucher, such as “Save Mart” -->
<merchant_id>...</merchant_id> <!-- Unique ID assigned to the particular merchant -->
<distributor>...</distributor> <!-- Advertisement company that distributes E-Voucher -->
<distributor_id>...</distributor_id> <!-- Unique ID assigned to the distributor -->

The content of an E-Voucher may change or be changed by any entity with permission to do so. Likewise an E-Voucher may include encryption and/or codes or other functionality to prevent tampering and fraud.

While an E-Voucher may include information about an offer, redemption of the offer, and any transaction associated with the redemption, it may also contain information about the voucher-recipient and the provision of the E-Voucher to the voucher-recipient. In the above example, the E-Voucher format allows for inclusion of information about the access date and access time. This information may be utilized by the transaction-entity, the voucher providing entity, and potentially other entities. For example, such information may be used individually or in combination with similar information for multiple E-Voucher-recipients to identify and track consumer preferences and for a variety of marketing purposes for which such information is known to be used.

An E-Voucher may be self-managed in the sense that it may contain all the information necessary for its use including the location of the depository in which it may be stored, the location of the transaction-entity with whom it may be redeemed, and the identity of one or more sources or providers who should be paid, or otherwise given credit for a successfully completed transaction. A self-managed electronic-voucher generally has certain rights and programmatically encoded attributes and contains information about the identity of the Web advertisement company delivered it, when it was downloaded by, or provided to, the customer, whether it has expired, etc. A self-managed E-Voucher generally offers advantages over a conventional, text-based, or URL-represented discount code, because of the extra information and manageability offered (for example, users can store an E-Voucher in an archive and can retrieve it anytime, versus writing a discount code down to paper and then forgetting to use it).

### Illustrative Embodiment of Advertising Using an E-Voucher

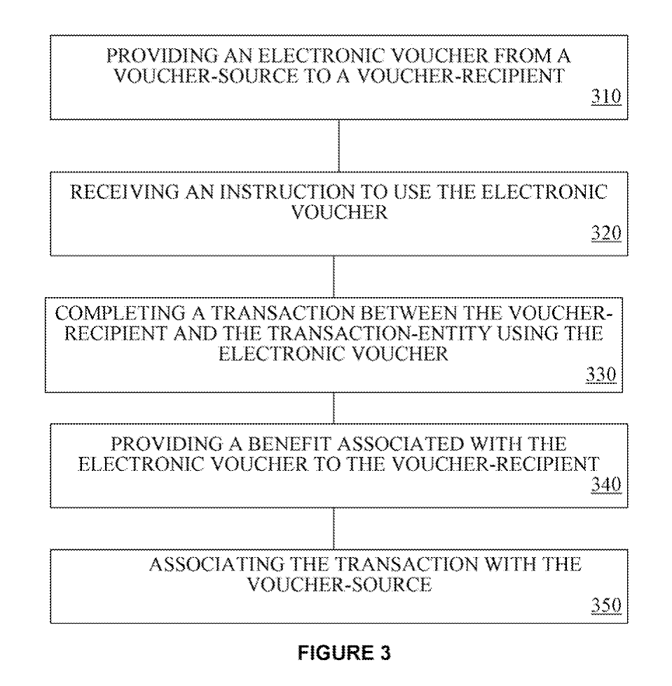

FIG. 3 is a flow chart illustrating one method of associating advertising with a transaction according to one embodiment of the present invention. For purposes of illustration only, the elements of this method are described with reference to the system depicted in FIGS. 1 and 2. A variety of other implementations are also possible.

In the method shown in FIG. 3, a voucher-source 20 provides an E-Voucher to a voucher-recipient computer 30, as shown in block 310. The E-Voucher offers a benefit to the voucher-recipient in return for completion of a transaction with a transaction-entity 40. The E-Voucher may comprise information identifying the benefit and the voucher-source 20. It may further comprise information associated with a purchase price discount, a name of the online merchant, a voucher-provided date, and a voucher-expiration date.

Presiding the E-Voucher to the voucher-recipient may be accomplished in a variety of ways including through Web ads, Web links, and merchandise advertisements. An E-Voucher may be delivered via an interactive button placed on a Web advertisement, or a button placed next to a link to a membership or credit application, or a merchandise listed in a Web site. Upon clicking on such a button, a downloadable content, such as an E-Voucher, can be delivered to the Web ad viewer or Web site user, for example by delivery to either a local or remote storage (a local hard drive or an online account).

Providing an E-Voucher to the voucher-recipient may also be accomplished by using E-mail, cell phone texting, instant messages, or otherwise by specifically sending the voucher to the recipient. For example, a user may receive an e-mail containing a link to download an E-Voucher. Upon clicking on the link, the user's computer 30 downloads the E-Voucher from the voucher-source 20 or another Web location. Such art e-mail might contain the E-Voucher as an attachment or in the body of the e-mail itself, as well as include a link to redeem the E-Voucher. Providing an E-Voucher to the voucher-recipient may involve a merchant or other entity printing an advertisement on a magazine that shows a barcode. A potential customer decodes the barcode, possibly by using a cell phone, to obtain the link to a page in a merchant's Web site, where one or more E-Vouchers can be obtained.

Providing the E-Voucher to the voucher-recipient may involve sending the E-Voucher to the transaction-entity 40 to complete the transaction. Thus, the E-Voucher may not physically be provided to the recipient computer 30, but instead may be provided to the transaction-entity 40 for the recipient's use in completing the transaction. In other words, the user doesn't have to store an E-Voucher locally, or even retrieve it from a remote storage. Instead, if the transaction-entity may be a part of the E-Voucher network and may provide a log-in screen for the customer to log in his/her E-Voucher depository, thus getting the needed E-Voucher delivered from the depository directly to the transaction-entity, without having been stored from the user's computer, or downloaded to it.

Providing the E-Voucher to the voucher-recipient may involve sending the E-Voucher to a depository 50 and in this case also may not involve sending the E-Voucher to the recipient computer 30. A message may be sent to the voucher-recipient confirming that the voucher has been provided. Thus, in providing the voucher to the voucher-recipient computer 30, the voucher-source 20 generally sends out the E-Voucher to the voucher-recipient computer 30, to the account depository 50, and/or to the transacts on-entity 40.

In the method shown in FIG. 3, one or more of the entities storing the E-Voucher (for example, the voucher-recipient computer 30, the account depository 50, and/or the transaction-entity 40) receives an instruction to use the E-Voucher, as shown in block 320. The instruction may, but need not, come from the voucher-recipient user 33. For example, an E-Voucher management application may identify or otherwise provide an instruction regarding the use of an appropriate E-Voucher. The instruction may, but need not, occur immediately after the provision of the E-Voucher 310 to the user. As an example, a user 33 at a voucher-recipient computer 30 may take an action to redeem an E-Voucher with the transaction-entity 40. This action may be part of the transaction contemplated by the offer of the E-Voucher. For example, the action may be sending a message to purchase an item from the transaction-entity 40. It should be noted that the E-Voucher redemption can be initiated in any suitable manner. For example, the user may invoke the E-Voucher or the transaction-entity may automatically retrieve an E-Voucher for a user, for example, during a transaction.

As a specific example, an individual wishing to purchase a pair of running shoes may provide an instruction to use an E-Voucher by, after navigating to the shoe manufacturer's Web page and selecting a desired shoe brand and style, selecting a user interface button on the shoe manufacturer's Web page to “USE E-VOUCHER.” Such selection may result in the automatic determination of an appropriate E-Voucher or may require further input from the shoe consumer. For example, the shoe consumer may be presented with options and asked to select from those options. Alternatively, the user may be asked to identify where the E-Voucher is stored

Alternatively, the shoe manufacturer Web site may provide the instruction to use an E-Voucher. For example, a Web site may receive a user's request to purchase a given style shoe and recognize that the user's E-Voucher account contains an appropriate E-Voucher. Having recognized this, the Web site may provide an instruction to use the appropriate E-Voucher,

In the method shown in FIG. 3, the transaction between the voucher-recipient computer 30 and the transaction-entity 40 is completed using the E-Voucher, as shown in block 330. Completing the transaction may comprise the voucher-recipient taking an action desired by the transaction-entity 40. For example, if the voucher-recipient took an action to purchase an item from the transaction-entity 40, the transaction-entity 40 could acknowledge the purchase of the item with a message or simply accept the purchase. Note that a purchased stem or service need not be delivered for the transaction to be considered completed. For present purposes, a transaction may be considered completed when the user/recipient has completed or otherwise taken the action required for redemption of the E-Voucher.

For example, if an E-Voucher requires purchase of a particular shoe style to receive the benefit of a 10% discount, the transaction between a shoe consumer and a shoe manufacturer may be considered complete when the shoe consumer has affirmatively committed to purchasing the particular style shoe.

The present invention is not limited to any particular sequence of interactions between the voucher-recipient and the transaction-entity. Rather, all that is generally required is that a transaction associated with an E-Voucher. The completed transaction need not be a purchase transaction. For example, the action may be one or more of making a purchase, making a sale, providing information, filling out a survey, providing an opinion, and providing a rating. As additional examples, the action could include a user completing an electronic survey, a user agreeing to do something, a user sending an e-mail, a user providing information, a user signing up for a new account, a user signing up for a method of payment, a user signing up for a credit card account, a user signing up for a frequent purchaser account, among the other transactions of among the virtually infinite number of potential actions that a transaction-entity may desire a user 33 to take in return for the benefit promised by an offer of an E-Voucher.

In the method shown in FIG. 3, the benefit of the E-Voucher is provided to the voucher-recipient computer 30 if the transaction is completed, as shown in block 340. Typically, this will happen at the time the transaction is completed or after the transaction is completed. For example, at the completion of a purchase transaction, the discount offered by an E-Voucher may be applied to reduce the purchase price. As another example, after a user signs up for a video rental membership, the user may be sent a card in the mail that can be used for a period to receive free video rentals. The transaction-entity 40 may, but need not, itself provide the benefit.

In the method shown in FIG. 3, the completed transaction is associated with the voucher-source, as shown in block 340. The identity of the voucher-source 20 is preferably obtained using the contents of the E-Voucher, but may be obtained by any suitable direct or indirect method. The method may further comprise determining an advertising fee associated with the E-Voucher. For example, the voucher-source 20 and transaction-entity 40 may have an agreement that the voucher-source 20 will be paid a set amount (for example, $1) or a set percentage (for example, 1%) for every transaction that is completed. As a more specific example, a shoe manufacturer may agree to pay a Web search engine $1 for every shoe sale that results from the Web search engine providing an E-Voucher to a search engine user who subsequently redeems the E-Voucher.

Once a transaction is completed, it is associated with one or more appropriate entities (for example a voucher source or content provider) for future payment of the advertising fee owed. Such fee or fees may he paid periodically, after each or a set number of completed transactions, or as is otherwise appropriate. For example, if a shoe manufacturer has agreed to pay a Web search engine $1 per redeemed E-Voucher, the shoe manufacturer may pay the Web search engine every month for the sales occurring in the preceding month, or may pay the Web search engine every 10,000 sales, or may pay the Web search engine on every sale. Any suitable payment arrangement may be used.

### Illustrative Embodiment of Advertising Using an E-Voucher Depository

An E-Voucher depository allows a user to retrieve stored E-Vouchers for redemption or other use. After download, the E-Voucher may be stored in local E-Voucher depository 34 residing in local memory 31, as shown in FIG. 1b, or in an account 52a residing in a networked storage 51, as shown in FIG. 1a. An E-Voucher depository may further allow an Internet user to organize E-Vouchers and provide other management functions that facilitate marketing and E-Voucher use. For example, an E-Voucher management application 35, 53a, could reside on the device or online and could be used to delete unwanted E-Vouchers, initiate the redemption of an E-Voucher, or set a reminder related to an E-Voucher.

On exemplary use of an E-Voucher depository is an Internet user establishing an account for storing and/or managing E-Vouchers, for example by simply providing a user name, password, and an e-mail address. After an account is established, the Internet user can collect E-Vouchers and add them into his/her account, for example looking for Web ads that have a button that, upon click, will ask (optionally) the user for account information, and send an E-Voucher to the E-Voucher depository associated with the user's identified account. The Internet user may use a management application to search, print, delete, annotate, and otherwise organize E-Vouchers stored in the depository associated with his or her account. Such an application may reside as a remote application at the remote account depository or elsewhere or may reside on the user's own computing device. For example, such an application could be an Adobe® AIR® application that communicates with the E-Voucher depository to log in and retrieve copies of die E-Vouchers.

An online merchant may access an E-Voucher depository. For example, at checkout, the merchant may be provided with a list of E-Vouchers for the current customer. If an applicable E-Voucher is found, the merchant may automatically use the E-Voucher, for example to apply a discount to the current, purchase. If more than one E-Voucher is found, a merchant may let the customer select one.

An E-Voucher depository may be implemented by creating a Web site that supports database transactions, including user accounts, logging in and out using user names and passwords, E-Voucher objects stored or otherwise deposited and organized per account, and an API that lets E-Voucher clients, merchants, and other entities to access user information and e-coupon collections. E-Voucher collection may also be facilitated by adding a button (such as an Adobe®Flash®-based button) to Web Content (such as a Web banner and Web ads that, upon selection, initiates an E-Voucher can be added to that user's E-Voucher depository account.

The relatively small amount of storage required to store many embodiments of E-Vouchers allows an account/depository system to potentially handle an enormous number of personal accounts, each account potentially having an enormous number of E-Vouchers.

An account system that can distribute information about one or more user account to a third-party and thus facilitate the completion of transactions in a variety of ways. For example, the account system could provide user information along with or as part of an E-Voucher to a third party transactional Web site.

In one embodiment, an E-Voucher is downloaded, cached, or otherwise and stored on a user's local device, for example in a local E-Voucher depository 34 residing in local memory 31, as shown in FIG. 1b. Security certificate information can be embedded within an E-Voucher for the purpose of E-Voucher integrity and origination verification. The E-Voucher's security information, in one embodiment, could be the base-64 presentation of an X.509 or a PKCS certificate.

Whether remote or local, an E-Voucher depository can be offered with a variety of features and provide a variety of benefits to the E-Voucher users and others. A user may be given an incentive to use an E-Voucher storage or account system, for example, with an additional reward offered for redeeming one or more E-Vouchers stored, or for simply allowing external parties' access to his or her E-Voucher collection so that the external parties can, by data mining, for example, identify purchase patterns, consumer interests, and a variety of other types of suitable statistical, qualitative, and quantitative information. The E-Vouchers stored in a user's account can be used to identify the user's current demands so that if there's a business that can fulfill such demands, it can proactively send promotions and offers to the user. As another example, an entity can identify an E-Voucher depository account holder's interests in a competitors products, and provide the account holder with the competitive offers. For the E-Voucher account holder's privacy, the information about the account holder shared with the external parties can be limited per the account holder's preferences. In one embodiment, the E-Voucher account holder can opt to share only certain information, for example, an e-mail address and home zip code, with third parties. In another embodiment, the account holder can be identified by the external parties with just a unique ID number, which the account holder can reset at any time.

An account and/or depository system may also allow an account and/or E-Vouchers to be accessed and used from remote locations and remote devices. Thus, a consumer may make a spontaneous decision to go out to dinner while visiting a city and search on his or her portable electronic device for preferable nearby restaurant. Such a search may utilize or otherwise search for or retrieve E-Vouchers offered by nearby restaurants, for example, by searching the user's account for E-Vouchers already stored for local restaurants or by searching local restaurant Web sites or accounts for appropriate E-Vouchers. Upon selection, an E-Voucher may he provided to the user's portable device or sent to the restaurant, for example as part of a reservation.

### Illustrative Method of Advertising Embodiment

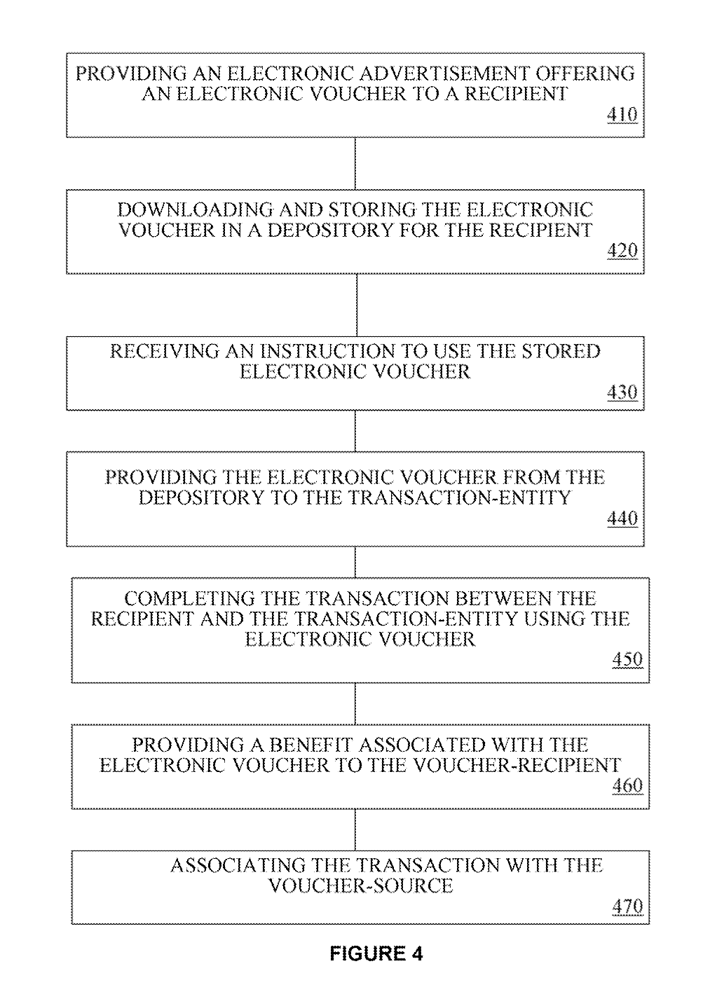

FIG. 4 is a flow chart illustrating one method of advertising according to one embodiment of the present invention. For purposes of illustration only, the elements of this method are described with reference to the system depicted in FIGS. 1 and 2. A variety of other implementations are also possible.

In the method shown in FIG. 4, a source, such as a web content source 60, provides an electronic advertisement to a recipient 30, as shown in block 410. For example, a web content source 60 may provide a Web page 62, an e-mail 64, or any other type of electronic media, that advertises the products or services of a transaction-entity 40. The advertisement or content provided therewith may also provide a link to download or otherwise receive an E-Voucher associated with the advertisement. For example, the Web content source may send an e-mail to a user with a graphic illustrating Brand Z bicycles and a Web link that allows the e-mail recipient to download an E-Voucher for 10% off a Brand Z bike purchase. Note that downloading a self-managed E-Voucher (as opposed to a conventional URL link or Web link represented by text or hypertext) may offer certain additional advantages including that the user is not forced to navigate away from the current Web page without having to open a new window or save the Web page or Web advertisement themselves.

Alternatively or in addition, an advertising e-mail may contain a link or carry a Web advertisement, that allows the recipient to purchase a Brand Z bike using an E-Voucher, without requiring the user to request to receive the E-Voucher. For example, the e-mail recipient may select the purchase link and have an Internet connection established with Brand Z. In the process, Brand Z may be provided with the E-Voucher telling it to apply a 10% discount and the identity of the source of the e-mail.

An advertisement or content provided with an advertisement may include an electronic voucher. For example, an e-mail advertisement may include an E-Voucher as downloadable content, or an attachment to the e-mail or in the body of the e-mail itself.

The electronic advertisement offers to provide an E-Voucher for the recipient's benefit. Specifically, the E-Voucher offers a benefit in return for completion of a transaction with a transaction-entity 40. For example, a celebrity gossip web page may include advertisements for Brand Q clothes associated with an E-Voucher. For example, the advertisement may include a photograph of a celebrity donning a Brand Q bathing suit and a link that says “Download an E-Voucher for $25 off Brand Q bathing suits,” E-Vouchers generally can be provided in a variety of contexts and in conjunction with a variety of additional content

In the method shown in FIG. 4, in response to an action by the recipient 34, the E-Voucher is downloaded and stored in a depository for the recipient 30, as shown in block 420. For example, the recipient may click on the link to “Download an E-Voucher for $25 off Brand Q bathing suits.” Alternatively, the recipient may save an E-Voucher from an e-mail to another location or to the depository.

Alternatively, the recipient 34 may fill out a form and receive an e-mail containing one or more E-Vouchers. Such e-mails may be sent periodically. Such e-mails may contain E-Vouchers specifically requested by the user, E-Vouchers related to the user's preferences, or E-Vouchers selected for any other suitable reason. The action by the recipient may have been signing up to receive offers and deals and need not relate directly to the specific E-Voucher. In certain embodiments, the advertisement and E-Voucher are provided together in response to the recipient's action, the recipient's past actions, and/or information about the recipient or the recipient's stored E-Vouchers. An E-Voucher may automatically be placed in the depository,

The depository may be physically located on a computer 30 used by the recipient 34, or may be remote from the recipient 34, for example, on a remote account depository 50. The depository may store one or a plurality of E-Vouchers provided to the recipient. The E-Vouchers may be associated with an account for the recipient 34. The depository may also comprise a plurality of accounts for storing E-Vouchers for multiple recipients.

In the method shown in FIG. 4, an instruction is received to use the E-Voucher stored in the depository, as shown in block 430. The instruction may be the result of the recipient 34 selecting an option in a depository account management tool to redeem a given E-Voucher. Alternatively, the recipient 34 may provide the instruction while accessing the transaction-entity's Web site or an online purchasing Web site such as AMAZON.COM and in the process of purchasing an item. The instruction may be prompted by the Web site recognizing that an E-Voucher is available and prompting the recipient to use the voucher. Thus, in certain embodiments the instruction will originate from the user and in other embodiments the instruction may originate from elsewhere and may or may not involve user interaction.

In the method shown in FIG. 4, the E-Voucher is provided from the depository 50 to the transaction-entity 40 for use in completing the transaction, as shown in block 440. This provision may, but need not, be an electronic transfer (such as, for example, download or e-mail) of the E-Voucher from the account depository 50 to the transaction-entity 40. For example, an E-Voucher in the form of a file may be sent through the network 10 to the transaction-entity 40.

In the method shown in FIG. 4, the transaction between the recipient and the transaction-entity is completed using the E-Voucher, as shown in block 450. As noted with respect to FIG. 3, the present invention is not limited to any particular sequence of interactions between the recipient and the transaction-entity and the completed transaction need not be a purchase transaction, but instead may be the completion of any action desired by a transaction-entity and rewarded by the E-Voucher.

To complete the transaction using the E-Voucher, the transaction-entity 40 may use the E-Voucher as a source of information. For example, an E-Voucher provided to a shoe consumer by a Web search provider that offers a 10% discount on the sale of a particular running shoe style may contain a reference to the identity of the Web search page provider as well as to the terms of the E-Voucher including the discount amount, the identity of the running shoe style, the offers expiration date, validation information, and any other information necessary or useful in facilitating the transaction.

In the method shown in FIG. 4, the benefit of the E-Voucher is provided to the recipient, as shown in block 460. This may happen at the time the transaction is completed or after the transaction is completed. For example, if an E-Voucher provides a $100 rebate after the sale of a particular computer monitor model, the computer monitor provider may provide the rebate within a few weeks of the monitor being shipped or otherwise provided. The transaction-entity 40 may, but need not itself provide the benefit. For example, a Web retailer may sell third party products with a rebate E-Voucher benefit provided by the product manufacturer.

In the method shown in FIG. 4, the completed transaction is associated with the voucher-source, as shown in block 470. The identity of the source 20 is preferably obtained using the contents of the E-Voucher, but may be obtained by any suitable direct or indirect method. For example, the E-Voucher may identify the provider with an ID number or contain information about the E-Voucher's transmission history. Thus, in certain embodiments, an E-Voucher records information as it is passed from one party to the next ensuring that compensation or other credit can be allocated appropriately. Such history may also be used for validation purposes as well as for consumer information purposes. In some eases, the E-Voucher records information about how the user completed the transaction and thus can be used to identify consumer preferences, tastes, and other valuable information.

The method may further comprise determining an advertising fee associated with the E-Voucher. The E-Voucher may, but need not, itself identify the terms of the advertising arrangement. For example, an E-Voucher for 10% off the purchase of a pair of a particular style running shoes may itself identify that an advertising party gets $1 for every redeemed E-Voucher.

One embodiment of the present invention provides an Application Programming Interface (API) defined so that online merchants can communicate effectively with an E-Voucher depository to retrieve, select, and redeem E-Vouchers and allow communication with the E-Voucher depository for billing purpose.

### Illustrative Embodiments of E-Voucher Management

An E-Voucher manager, for example an E-Voucher management client device application, can be used to manage E-Vouchers. For example, a local application may be used to facilitate the downloading and managing of E-Vouchers from online sources or online storage. Such an application may remind a user if an E-Voucher is about to expire, let the user search for E-Vouchers using search criteria, or even suggest E-Vouchers based on search criteria and other factors, such as user preferences, account information, related E-Vouchers, date of the month, or the day of the week.

A client application, such as an E-Voucher Manager 35 residing for example on device 30 shown in FIG. 1b, may determine and provide reminders to use E-Vouchers. For example, the E-Voucher Manager 35 can periodically check a voucher depository for voucher expiration dates and send one or more appropriate reminders. Such an E-Voucher Manager 35 may also include search and suggest functions. For example, the E-Voucher Manager 35 may include a search engine that allows a user to search for E-Vouchers in the user's depository-account and/or for E-Vouchers that are available at remote Web sites or through a voucher provider. As another example, the E-Voucher Manager 35 may have information about the user's preferences, wish list, personal information, prior voucher receipts, prior purchases, and/or other relevant information, and use such information to make suggestions.

An E-Voucher Manager 35 may include functionality to search for “better” E-Vouchers and other information to help ensure that a user is getting the best deal available on a given purchase. The E-Voucher Manager 35 may provide for automatic searching, and/or manual searching. The searching may be intelligent in the sense that it may take into account the user's preferences, wish list, personal information, prior voucher receipts, prior purchases, external data such as day of the week, and/or other relevant, information.

An E-Voucher Manager 35 can make periodic Internet, searches for better deals. For example, it may recognize that there is a 10% off voucher in the user's account usable if a pair of brand X running shoes are purchased from brand X's Web site. The management application may periodically search brand X's Web site and elsewhere on the Internet to see if there are any better offers. Upon finding one, for example, an offer for 15% off, the application may notify the user. Likewise, the application may search for E-Coupons related to previously redeemed or stored E-Vouchers. For example, the application could identify that the user previously redeemed a voucher for a Brand Y video game system. With this information, the application could periodically search for video games for the Brand Y video game system and make the user aware of video game products and related E-Vouchers and promotions.

Alternatively, an E-Voucher Manager 53a may be located at an account depository 50 and accessed remotely from recipient computer 30.

A E-Voucher management client application could be written as a multi-platform or script-based application, or a Rich Internet Application (such, as Adobe® AIR.®) so that it is small in size, works across different computing devices, can obtain online information quickly, and perform or facilitate logical searches and suggestions. An E-Voucher management application may also be available on mobile devices such as PDA's and cell phones and may be able to communicate with, interact with, or otherwise utilize an E-Voucher depository or account of E-Vouchers to retrieve, add, or manage E-Vouchers or other information as needed. For example, an E-Voucher Manager may be able to read the expiration and other “fine-print” information that may be part of an E-Voucher to provide reminders and suggestions to the user.

A variety of management applications and uses of management applications are possible. In one embodiment, a user logs into his or her account by typing in a user ID and password using the E-Voucher management client. The user is provided with a list of the E-Vouchers accumulated to date and is able to retrieve a particular E-Voucher and/or download it to the local device for use. The user may also use the management application to perform searches. In response to such a search, a user may be provided with a list of matched E-Voucher from his/her account, in the depository. A search user interface may comprise one or more text boxes for the user to enter search terms, and a list of radio buttons, check-boxes, and dropdown list boxes, to add refinements to the search. For example, if the user wants to search for an E-Voucher used for a video rental store named “VIDEO STORE B” and located within 10 miles from the user's home, he/she will type in “VIDEO STORE B” in the search text box, and locate a distance drop-down list box, and select the criteria “10 miles or less”. An B-Voucher search feature may also intelligently parse search information provided by a user or otherwise facilitate searching. As other examples of searching, a user may enter the name of an activity, the name of a store, the name of a product, and/or information about pricing among any other suitable search criteria.

An E-Voucher management application may also use demographic and/or user information (e.g. ethnic, income, interests, etc.) or preferences., for example to recommend E-Vouchers that are appropriate with the user's consumer profile or preferences.

### Illustrative E-Coupon Embodiment

in one embodiment, a customer obtains an E-Coupon, which is a specialized type of E-Voucher that expressly provides a purchase price discount as its benefit. The E-Coupon is obtained front a Web advertisement for a merchant's product. The customer visits the merchant's Web site and makes a purchase. At the checkout stage, the merchant's Web site automatically checks with the customer's account in an E-Coupon depository to obtain a relevant E-Coupon. If there is more than one E-Coupon available, the merchant will let the customer choose which E-Coupon to redeem. When the customer clicks on a “Submit” button to finalize the transaction, the E-Coupon communicates back to the E-Coupon depository so that the E-Coupon company can bill the merchant later. The E-Coupon model also makes shopping and purchasing convenient for customers.

E-Coupons may be used in an advertising fee arrangement in which a merchant agrees to pays only if a customer has actually made a purchase. The merchant agrees to provide (or cause to be provided) the benefit specified by the E-Coupon (for example, a discount on the purchase price). The merchant pays for advertisements only after the advertisement has worked. The E-Coupon also serves as a “come back reminder” or “eyeball gainer” as well. And, a merchant can select characteristics of an E-Coupon so that a coupon provided to a user for later use will remind the user to redeem the E-Coupon or look for new E-Coupons.

### Illustrative Web Advertisement Embodiment

One method of an embodiment of the present invention is a method of providing an electronic voucher to a recipient that comprises providing an electronic advertisement as part, of a Web page. The electronic advertisement may provide a download-electronic-voucher option that allows a recipient viewing the Web advertisement to download an electronic voucher offering a benefit to the recipient in return for completion of a transaction using the electronic voucher. Upon a selection of the download-electronic-voucher option, the electronic voucher is provided to the recipient. For example, the Web advertisement may contain a button that allows a recipient to download an E-Voucher. The selection of the download-electronic-voucher option may not require the recipient to navigate to a different Web site, open a new window, save the Web page or the Web advertisement, and/or save a link.

### General

The foregoing description of the embodiments of the invention has been presented only for the purpose of illustration and description and is not intended to be exhaustive or to limit the invention to the precise forms disclosed. Numerous modifications and adaptations are apparent to those skilled in the art without departing from the spirit and scope of the invention.

1. A computer-implemented method comprising:
providing an electronic advertisement from a computer device associated with a first entity through a network to a recipient, the electronic advertisement associated with an electronic voucher offering a benefit to the recipient in return for completion of a transaction using the electronic voucher, wherein the electronic advertisement is provided under a fee arrangement between the first entity and a second entity, the second entity agreeing to pay the first entity an advertising fee based on completion of the transaction, wherein the electronic voucher comprises information identifying the first entity;
receiving, at a computer device associated with the first entity, confirmation that the recipient completed the transaction to redeem the electronic voucher, the transaction completed online and comprising the recipient sending the electronic voucher through the network to the second entity; and
using the electronic voucher sent through the network to the second entity in completing the transaction to associate the transaction with the first entity, wherein the information identifying the first entity is obtained from the electronic voucher to associate the transaction with the first entity.

2. The method of claim 1, wherein the electronic voucher comprises an electronic file, a text file, an XML file, an Internet cookie, a binary, executable, or script-based application.

3. The method of claim 1, wherein the electronic voucher is an electronic coupon, the benefit is a purchase price discount, and the transaction is an online purchase from an online merchant in which the recipient accesses a website of the online merchant.

4. The method of claim 3, wherein the electronic coupon comprises information associated with the purchase price discount, a name of the online merchant, a voucher-provided date, a voucher restriction, and a voucher-expiration date.

5. (canceled)

6. A computer-implemented method comprising:
receiving, at a computer device of a transaction entity, an instruction to use an electronic voucher in a transaction between a voucher-recipient and the transaction-entity, the electronic voucher offering a benefit to the voucher-recipient in return for completion of the transaction with the transaction-entity, the voucher-recipient having received the electronic voucher from a voucher-source computer device that sent the electronic voucher through a network to a computer device of the voucher-recipient, wherein the electronic voucher comprises information identifying the voucher-source;
completing, at the computer device of a transaction-entity, the transaction between the voucher-recipient and the transaction-entity using the electronic voucher, wherein the transaction is completed online and comprises the voucher-recipient sending the electronic voucher through the network to the transaction-entity, and wherein the benefit of the electronic voucher is provided to the voucher-recipient in return for completion of the transaction; and
using the electronic voucher sent through the network to the transaction entity in completing the transaction to associate the transaction with the voucher-source, wherein the information identifying the voucher source is obtained from the electronic voucher to associate the transaction with the voucher source.

7. The method of claim 6, wherein the instruction to use the electronic voucher is from the voucher recipient.

8. The method of claim 6, further comprising determining an advertising fee associated with the electronic voucher.

9. (canceled)

10. The method of claim 6, further comprising downloading the electronic voucher to a computer account associated with the voucher-recipient.

11. The method of claim 6, further comprising downloading the electronic voucher to a location accessible for later use by the voucher-recipient.

12. The method of claim 6, wherein the electronic voucher was sent to the voucher-recipient in an e-mail.

13. The method of claim 6, wherein the voucher-recipient downloaded the electronic voucher from a Web location.

14. The method of claim 6, wherein completing the transaction further comprises the voucher-recipient taking an action desired by the transaction-entity.

15. The method of claim 14, wherein the action is selected from the group consisting of: making a purchase; making a sale; providing information; filling out a survey; providing an opinion; and providing a rating.

16. The method of claim 6 further comprising crediting an advertising fee to be paid to the voucher source based on completion of the transaction.

17. A computer-implemented method comprising:
storing an electronic voucher in a depository, wherein the depository is a computer device, wherein the electronic voucher is associated with an account for a recipient of the electronic voucher, the electronic voucher offering a benefit to the recipient in return for completion of a transaction with a transaction-entity, wherein the electronic voucher comprises information identifying a voucher source that provided the electronic voucher for use by the recipient;
receiving, at the depository, an instruction to use the electronic voucher stored in the depository with the transaction between the recipient and the transaction-entity;
providing the electronic voucher from the depository through a network to the transaction-entity for use in completing the transaction between the recipient and the transaction-entity, wherein the transaction is completed online and comprises the recipient sending a message through the network to the transaction-entity, and wherein the benefit of the electronic voucher is provided to the recipient in return for completion of the transaction; and
using the electronic voucher sent through the network to the transaction entity in completing the transaction to associate the transaction with the voucher source, wherein the information identifying the voucher source is obtained from the electronic voucher to associate the transaction with the voucher source.

18. The method of claim 17, wherein the instruction is received from the recipient.

19. The method of claim 17, wherein the depository is on a computer used by the recipient.

20. The method of claim 17, wherein the depository is remote from the recipient.

21. The method of claim 17, wherein the depository stores a plurality of electronic vouchers provided to the recipient, the plurality of electronic vouchers associated with the account for the recipient.

22. The method of claim 17, wherein the depository comprises a plurality of accounts for storing electronic vouchers.

23. The method of claim 17 further comprising determining an advertising fee to be paid to the voucher source.

24. The method of claim 17 further comprising determining an advertising fee to be paid to a provider of the electronic voucher different from the voucher source.

25. The method of claim 17 further comprising providing an electronic advertisement to the recipient offering to associate the electronic voucher with the account for the recipient, wherein a source from which the electronic advertisement is provided is the same as the voucher source.

26. The method of claim 17 further comprising providing an electronic advertisement to the recipient offering to associate the electronic voucher with the account for the recipient, wherein a source from which the electronic advertisement is provided is different than the voucher source.

27. A computer-readable medium on which is encoded program code, the program code comprising:
program code for receiving, at a computer device of a transaction entity, an instruction to use an electronic voucher, the electronic voucher offering a benefit to the voucher-recipient in return for completion of the transaction with the transaction-entity, the voucher-recipient having received the electronic voucher from a voucher-source computer device that sent the electronic voucher through a network to a computer device of the voucher-recipient, wherein the electronic voucher comprises information identifying an entity associated with the voucher-source computer device;
program code for completing, at the computer device of a transaction-entity, the transaction between the voucher-recipient and the transaction-entity using the electronic voucher, wherein the transaction is completed online and comprises the voucher-recipient sending a message or the electronic voucher through the network to the transaction-entity, and wherein the benefit of the electronic voucher is provided to the voucher-recipient in return for completion of the transaction; and
program code for using the electronic voucher sent through the network to the transaction entity in completing the transaction to associate associating the transaction with the entity associated with the voucher-source computer device, wherein using the information identifying the entity associated with the voucher-source computer device is obtained from the electronic voucher to associate the transaction with the entity associated with the voucher source computer device.

28. The computer readable medium of claim 27, further comprising program code for managing an electronic voucher depository comprising program code for searching, suggesting, and retrieving an electronic voucher.

29. A computer-implemented method comprising:
providing, from a first computing device, an electronic advertisement as part of a Web page, the electronic advertisement providing a download-electronic-voucher option that allows a recipient viewing the Web page to download an electronic voucher offering a benefit to the recipient in return for completion of a transaction using the electronic voucher, wherein the electronic voucher comprises information identifying a source of the electronic advertisement;
upon a selection of the download-electronic-voucher option, providing the electronic voucher to a second computing device of a recipient for use in completing the transaction, wherein the transaction is completed online and comprises the recipient sending the electronic voucher through a network to a transaction-entity, and wherein the benefit of the electronic voucher is provided to the recipient in return for completion of the transaction; and
using the electronic voucher sent through the network to the transaction entity in completing the transaction to associate the transaction with the source of the electronic advertisement, wherein the information identifying the source of the electronic advertisement is obtained from the electronic voucher to associate the transaction with the source.

30. The method of claim 29, wherein the selection of the download-electronic-voucher option does not require the recipient to navigate to a different Web site, open a new window, save the Web page, or save a link.

31. The method of claim 1, wherein the transaction is associated with the first entity without requiring manual entry of a code identifying the first entity.

32. The method of claim 1 further comprising allocating compensation or credit using information that is recorded in the electronic voucher as the electronic voucher is passed from party to party.

33. The method of claim 1 further comprising identifying consumer information using information about how the transaction was completed that is recorded in the electronic voucher.
